(19) United States
(12) Patent Application Publication
(10) Pub. No.: US 2020/0331431 A1
(43) Pub. Date: Oct. 22, 2020

(54) ENGINE SWITCH DEVICE

(71) Applicant: KABUSHIKI KAISHA TOKAI RIKA DENKI SEISAKUSHO, Aichi (JP)

(72) Inventor: Akira FUSHIMI, Aichi (JP)

(73) Assignee: KABUSHIKI KAISHA TOKAI RIKA DENKI SEISAKUSHO, Aichi (JP)

(21) Appl. No.: 16/643,232

(22) PCT Filed: Aug. 29, 2018
(86) PCT No.: PCT/JP2018/031945

§ 371 Date: Feb. 28, 2020

(30) Foreign Application Priority Data
Sep. 14, 2017 (JP) 2017-176873

(51) Int. Cl. B60R 25/04; B60R 25/25; B60R 25/24; B60R 25/10; F02N 11/08; G06K 9/00

(52) U.S. Cl. CPC B60R 25/04; B60R 25/252; B60R 25/24; G06K 9/00087; F02N 11/087; G06K 9/00067; B60R 25/10

(57) ABSTRACT

An engine switch device is disclosed by which the engine is permitted to be started using an engine switch when biometric authentication executed on the basis of biometric information sensed by a biometric authentication sensor is successful. This engine switch device includes: an authentication determination unit configured so as to determine that biometric authentication is successful when previously-stored biometric information matches the biometric information sensed by the biometric authentication sensor; an alternative authentication unit configured so as to execute an alternative authentication based on a user performing a prescribed operation vis-à-vis the engine switch when the biometric authentication fails; and an activation permission unit configured so as to permit or execute an engine start when the biometric authentication is successful and further configured so as to permit or execute the engine start when the biometric authentication fails and alternative authentication by the alternative authentication unit-is successful.

### TECHNICAL FIELD

The present invention relates to an engine switch device.

### BACKGROUND ART

When a biometric authentication electronic key system known in the art authenticates a user who is attempting to control a vehicle as the authentic user, the system performs key verification to check whether an electronic key is valid and biometric authentication to check whether biometric information of the user is valid (patent document 1). The biometric authentication electronic key system includes a controller that compares biometric information of the user that is stored in advance with biometric information that is detected by a biometric information sensor. When the biometric information of the user that is stored in advance matches the detected biometric information, the controller determines that the user who is attempting to control the vehicle is the authentic user.

In such a biometric authentication electronic key system, the vehicle cannot be controlled unless key verification and biometric authentication are both accomplished. This ensures security against vehicle theft.

### PRIOR ART DOCUMENT

### Patent Document

Patent Document 1: Japanese Laid-Open Patent Publication No. 2005-239079

### SUMMARY OF THE INVENTION

### Problems that the Invention is to Solve

Under an unexpected situation, biometric authentication may fail even when the biometric authentication is performed on the authentic user. For example, in a case where fingerprint authentication is performed as the biometric authentication, when the user wounds his or her fingertip or when the fingertip is wet by rain or the like, the fingerprint of the fingertip may be recognized as being different from what it should be. This would result in fingerprint authentication failure even though the authentic user is performing the fingerprint authentication. When fingerprint authentication fails, vehicle operations, such as the starting of the engine, will not be permitted. If the user wishes to operate the vehicle when fingerprint authentication fails, the user will have to take out the electronic key. This is inconvenient.

It is an object of the present invention to provide an engine switch device that is more convenient to the user.

### Means for Solving the Problem

One aspect of the present invention is an engine switch device that permits starting of an engine with an engine switch if biometric authentication executed based on biometric information detected by a biometric authentication sensor is accomplished. The engine switch device includes a biometric authentication determination unit configured to determine that the biometric authentication has been accomplished if biometric information that is stored in advance matches the biometric information detected by the biometric authentication sensor, an alternative authentication unit configured to execute alternative authentication based on a predetermined operation performed on the engine switch by a user if the biometric authentication fails, and an actuation permission unit configured to permit or perform starting of the engine if the biometric authentication is accomplished and further configured to permit or perform starting of the engine if the biometric authentication fails but the alternative authentication performed by the alternative authentication unit is accomplished.

In a comparative example, alternative authentication is not provided. In this case, starting of the engine is not permitted or executed when biometric authentication fails. Thus, if the user wishes to start the engine even though biometric authentication has failed, instead of operating the engine switch, a different authentication needs to be performed by, for example, operating a device such as an electronic key. However, in this case, the user will have to take out the device. This is inconvenient.

In this regard, when alternative authentication is provided, even if biometric authentication fails, starting of the engine is permitted or executed if the alternative authentication is accomplished when the user performs a predetermined operation on the engine switch. Thus, alternative authentication can be accomplished by operating the engine switch in the same manner as when performing biometric authentication, and there is no need to take out any device. This is more convenient to the user when starting the engine.

Preferably, the engine switch device includes a key verification unit configured to execute key verification based on whether an electronic key ID that is transmitted through wireless communication from an electronic key held by the user matches a registration ID that is stored in advance. The actuation permission unit is configured to permit or perform starting of the engine if the biometric authentication and the key verification are both accomplished. The actuation permission unit is further configured to permit or perform starting of the engine if the biometric authentication fails but the alternative authentication and the key verification are both accomplished.

With this configuration, starting of the engine is permitted or performed as long as smart verification and alternative authentication are both accomplished even if smart verification and biometric authentication are both not accomplished.

Preferably, the engine switch device further includes a failure notification unit configured to notify the user of failure of the biometric authentication using the engine switch or an electronic key held by the user if the biometric authentication fails.

With this configuration, the user will be notified by the failure notification unit that biometric authentication has failed. Thus, the user can acknowledge that alternative authentication needs to be accomplished to have starting of the engine permitted or performed when biometric authentication has failed.

Preferably, in the engine switch device, the alternative authentication is performed only during a predetermined time from when failure of the biometric authentication is determined.

This configuration limits the time for alternative authentication, which is intentionally performed by the user, and thereby ensures security for alternative authentication.

Preferably, the engine switch device further includes the engine switch that includes an operation surface and the biometric authentication sensor including a fingerprint sensor arranged on the operation surface of the engine switch. The fingerprint sensor is configured to detect a fingerprint serving as the biometric information.

With this configuration, biometric authentication is executed based on whether the fingerprint detected by the fingerprint senor matches a fingerprint that is stored in advance.

Preferably, in the engine switch device, the fingerprint sensor detects the predetermined operation performed on the engine switch by the user during the alternative authentication, and the alternative authentication unit is further configured to determine that the alternative authentication has been accomplished if a touching action performed by the user on the operation surface of the engine switch matches an action that is stored in advance.

With this configuration, alternative authentication is accomplished if a touching action performed by the user on the engine switch matches an action that is stored in advance because this would be the predetermined operation of the user.

Preferably, in the engine switch device, the predetermined operation includes touching the operation surface of the engine switch for a number of times that is registered in advance.

With this configuration, alternative authentication is accomplished when detecting that the operation surface of the engine switch has been touched for the number of times that is stored in advance because this would be the predetermined operation of the user.

Preferably, in the engine switch device, the predetermined operation includes operating and touching the operation surface of the engine switch along a route that is registered in advance.

With this configuration, alternative authentication is accomplished when detecting that the operation surface of the engine switch is operated and touched in a direction registered in advance.

A further aspect of the present invention is a system that starts an engine of a vehicle. The system includes one or more processors and a memory connected to the one or more processors to store commands executable by the one or more processors and biometric information of a user of the vehicle. The one or more processors executes the commands to determine that biometric authentication has been accomplished if the biometric information stored in the memory matches biometric information detected by a biometric authentication sensor, execute alternative authentication based on a predetermined operation performed on an engine switch by a user if determined that the biometric authentication has failed, permit or perform starting of the engine if determined that the biometric authentication has been accomplished, and permit or perform starting of the engine if the alternative authentication is accomplished when determined that the biometric authentication has failed.

### Effects of the Invention

The engine switch device according to the present invention is more convenient to the user.

### BRIEF DESCRIPTION OF THE DRAWINGS

FIG. 1 is a diagram showing the configuration of a biometric authentication electronic key system in accordance with one embodiment.

FIG. 2 is a diagram illustrating a radio wave area formed outside the passenger compartment when exterior smart communication is performed.

FIG. 3 is a diagram illustrating a radio wave area formed inside the passenger compartment when interior smart communication is performed.

FIG. 4 is a schematic diagram illustrating operation of an engine switch by a user.

FIG. 5 is a flowchart illustrating the procedure for permitting power shifting by operating the engine switch based on whether alternative authentication is accomplished.

### MODES FOR CARRYING OUT THE INVENTION

An engine switch device in accordance with one embodiment will now be described.

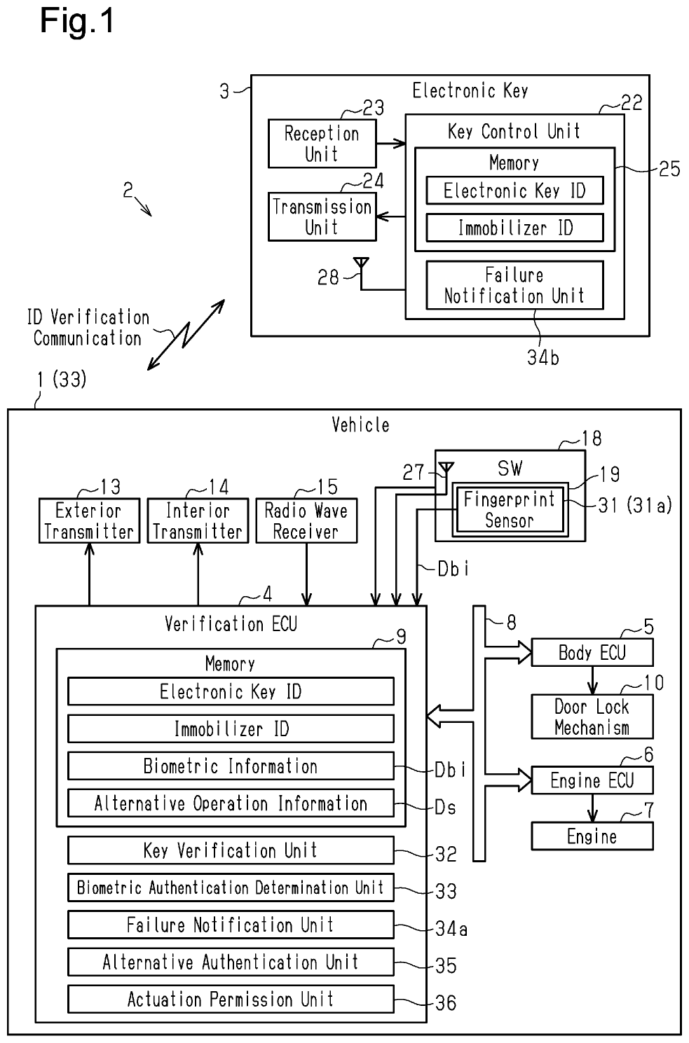

As shown in FIG. 1, a biometric authentication electronic key system 2 that performs both key verification and biometric authentication to authenticate a user. Biometric authentication uses information unique to each individual (biometric information), such as fingerprint, voiceprint, face, veins, iris, and retina, to check whether the user who is attempting to control the vehicle 1 is the authentic user. In the present embodiment, fingerprint authentication, which is authentication that checks the fingerprint of the user, is used as the biometric authentication.

The biometric authentication electronic key system 2 performs ID verification on an electronic key 3, which is a vehicle key, through near-field communication when wide-area communication with the vehicle 1 is established. Key verification is verification that checks whether the electronic key 3 is valid through ID verification performed through wireless communication with the electronic key 3. Key verification includes, for example, verification performed by a key-operation-free system, which performs ID verification through near-field communication with the electronic key 3 when wireless communication with the vehicle 1 is established, and verification performed by an immobilizer system, which performs ID verification through short-distance communication between the vehicle 1 and the electronic key 3. Here, ID verification performed by a key-operation-free system will be referred to as “smart verification” and ID verification performed by an immobilizer system will be referred to as “immobilizer verification.” The immobilizer system is an alternative key system used when smart verification cannot be performed due to battery drainage of the electronic key 3.

The vehicle 1 includes a verification electronic control unit (ECU) 4 that performs ID verification, a body ECU 5 that manages power for on-board electric devices, and an engine ECU 6 that controls an engine 7. These ECUs are connected by a communication line 8 inside the vehicle. For example, a controller area network (CAN) is used as the communication line 8. The verification ECU 4 includes a memory 9. An electronic key ID and an immobilizer ID, which are registered to the vehicle 1, are written to and stored in the memory 9. The body ECU 5 controls actuation of a door lock device 10 arranged in a vehicle door to switch the door between locked and unlocked states.

Further, the vehicle 1 includes an exterior transmitter 13 that transmits radio waves outside a passenger compartment through smart communication, an interior transmitter 14 that transmits radio waves inside the passenger compartment through smart communication, and a radio wave receiver 15 that receives radio waves through smart communication in the vehicle 1. The exterior transmitter 13 and the interior transmitter 14 transmit radio waves on, for example, the low frequency (LF) band. The radio wave receiver 15 receives radio waves on, for example, the ultrahigh frequency (UHF) band.

An engine switch 18 arranged in the vehicle 1 is operable for switching on and off the vehicle power. The engine switch 18 is a push-type switch, which includes a knob 19 that is pushed, and a push-momentary type switch, which returns to an original initial position when the pushed knob 19 is released. The engine switch 18 is push-operated to shift the vehicle power to any one of IG off, ACC on, and engine start states.

The electronic key 3 includes a key control unit 22 that controls actuation of the electronic key 3, a reception unit 23 that receives radio waves in the electronic key 3, and a transmission unit 24 that transmits radio waves in the electronic key 3. The key control unit 22 includes a memory 25. The electronic key ID and the immobilizer ID, which are unique to the electronic key 3, are written to and stored in the memory 25. The reception unit 23 receives the LF radio waves transmitted from the exterior transmitter 13 and the interior transmitter 14. The transmission unit 24 transmits, for example, UHF radio waves. The radio wave receiver 15 of the vehicle 1 receives the UHF radio waves transmitted from the transmission unit 24.

The vehicle 1 includes an immobilizer antenna 27 that transmits and receives radio waves to and from the electronic key 3 through immobilizer communication performed during immobilizer verification. The immobilizer antenna 27 is formed by, for example, a coil antenna and incorporated in the engine switch 18. The electronic key 3 also includes an immobilizer antenna 28 used to communication with the immobilizer antenna 27 of the vehicle 1. The immobilizer communication performed between the immobilizer antennas 27 and 28 is near-field wireless communication that is in compliance with the radio-frequency identification (RFID) standard. The communication area for immobilizer communication is set to, for example, a range of a few centimeters.

The verification ECU 4 includes a key verification unit (32) that executes smart verification by obtaining the electronic key ID through wireless communication from the electronic key 3 during smart communication and checking whether the obtained electronic key ID is valid. More specifically, the verification ECU 4 determines whether the obtained electronic key ID matches the electronic key ID stored in the memory 9 to execute smart verification. Smart verification includes exterior smart verification that executes ID verification with the electronic key 3 located outside the passenger compartment when the exterior transmitter 13 establishes communication and interior smart communication that executes ID verification with the electronic key 3 located inside the passenger compartment when the interior transmitter 14 establishes communication. Further, the verification ECU 4 obtains the immobilizer ID through wireless communication from the electronic key 3 during immobilizer communication. Then, the verification ECU 4 executes immobilizer verification by checking whether the obtained immobilizer ID is valid. More specifically, the verification ECU 4 determines whether the obtained immobilizer ID matches the immobilizer ID stored in the memory 9 to execute immobilizer verification.

The vehicle 1 further includes a sensor unit 31 functioning as a biometric authentication sensor that detects biometric information Dbi of the user. The sensor unit 31 is disposed on one element or any of a plurality of elements operated from when the user enters the passenger compartment to when the user starts the engine 7. The sensor unit 31 is arranged on, for example, an operation surface 19 of the engine switch (18). In the present embodiment, the sensor unit 31 is arranged on the knob 19 of the engine switch 18. For example, a fingerprint sensor 31a is employed as the sensor unit 31. The fingerprint sensor 31a detects the fingerprint of the user as the biometric information Dbi based on a change in charge inside the fingerprint sensor 31a when the user touches the surface (operation surface) of the fingerprint sensor 31a with a finger.

The biometric information Dbi of the authentic user is registered in advance to the memory 9 of the verification ECU 4. The verification ECU 4 includes a biometric authentication determination unit 33 that executes biometric authentication by comparing the biometric information Dbi detected by the sensor unit 31 with the biometric information Dbi stored in the memory 9. When the verification ECU 4 determines that smart verification and biometric authentication have both been accomplished, the verification ECU 4 permits power shifting of the vehicle 1 through operation of the engine switch 18. If power shifting of the vehicle 1 is permitted, the engine 7 is started when the user operates the engine switch 18.

Further, the biometric authentication electronic key system 2 includes an alternative function that permits starting of the engine 7 (device) even when biometric authentication performed between the electronic key 3 and its communication peer (e.g., the vehicle 1) fails. More specifically, even if biometric authentication fails when key verification is accomplished, the biometric authentication electronic key system 2 permits starting of the engine 7 when key verification and alternative authentication performed by the alternative function are accomplished. In the prior art, when smart verification is accomplished but biometric authentication fails, to start the engine 7 of the vehicle 1, the user will have to take out the electronic key 3 inside the passenger compartment to perform immobilizer verification. This is inconvenient. In particular, when the user wounds the finger used for fingerprint authentication or when the finger is wet by rain, fingerprint authentication will have a tendency to fail. In such a case, the user will have to take out the electronic key 3 inside the passenger compartment. This is inconvenient. If the electronic key 3 has to be taken out inside the passenger compartment, this will lower the advantage of smart communication that permits starting of the engine 7 without holding the electronic key 3 with the hand. With regard to this point, in the present embodiment, when the user fails biometric authentication, if alternative authentication is accomplished, the biometric authentication electronic key system 2 permits starting of the engine 7 without the user having to take out the electronic key 3. Preferably, locking and unlocking of the door of the vehicle 1 is performed through normal key verification such as smart verification or wireless verification.

The biometric authentication electronic key system 2 includes failure notification units 34a and 34b that notify the user of biometric authentication failure. The failure notification unit 34a is arranged in the verification ECU 4 of the vehicle 1, and the failure notification unit 34b is arranged in the key control unit 22 of the electronic key 3. The failure notification units 34a and 34b cooperate to issue a biometric authentication failure notification by, for example, using the engine switch 18 to show a message or generating a voice notification.

The biometric authentication electronic key system 2 includes an alternative authentication unit 35 that executes alternative authentication when the user, who has received a biometric authentication failure notification, performs a predetermined operation on the engine switch 18. The alternative authentication unit 35 is arranged in the verification ECU 4. The predetermined operation for accomplishing alternative authentication may be tapping (touch-operating) the sensor unit 31 a predetermined number of times and tracing (operating while touching) the sensor unit 31 in a predetermined direction.

The alternative authentication unit 35 determines that the predetermined operation has been performed when, for example, the sensor unit 31 (fingerprint sensor 31a) is successively touched three times at predetermined first time intervals, then successively touched again five times at the predetermined first time intervals when a predetermined second time elapses, and further successively touched two times at the predetermined first time intervals when the predetermined second time elapses again. Even if the successive touching is performed at time intervals slightly differing from the first time intervals, the alternative authentication unit 35 will determine that successive touching has been performed as long as the difference is within a tolerable range. Further, the alternative authentication unit 35 may determine the number of times successive touching is performed based on the number of times touching is performed within a predetermined time. Alternative operation information Ds corresponding to the predetermined operation is stored in advance in the memory 9. The alternative operation information Ds is registered to the memory 9 at the same time as when the user registers his or her fingerprint. The predetermined operation (alternative operation information Ds) is freely determined by the user and thus may be in any form as long as the form of the operation is acceptable. For instance, the predetermined operation may be tracing of the sensor unit 31 along a route determined in advance by the user. In one example, the alternative authentication unit 35 determines that the predetermined operation has been performed when the sensor unit 31 detects rightward, rightward, downward, and leftward tracing within a predetermined time. Further, the alternative authentication unit 35 may determine that the predetermined operation has been performed when the sensor unit 31 detects that the finger of the user has taken a predetermined route from when touching the sensor unit 31 to when moving the finger away from the sensor unit 31. In this manner, the route for tracing the sensor unit 31 is registered in advance to the memory 9 as alternative operation by the user, and the verification ECU 4 determines that the predetermined operation has been performed when the user traces the sensor unit 31 along the registered route.

The fingerprint sensor 31a, which serves as the sensor unit 31, is configured to detect fingerprints. The fingerprint sensor 31a detects when the finger of the user touches its surface based on a change in the charge inside the fingerprint sensor 31a. Further, the fingerprint sensor 31a detects when the finger touching the fingerprint sensor 31a moves, that is, the route of the finger tracing the fingerprint sensor 31a based on a change in the charge inside the fingerprint sensor 31a.

The alternative authentication unit 35 checks whether alternative authentication, which is an alternative to biometric authentication, is accomplished based on whether the predetermined operation registered by the user is detected.

The verification ECU 4 of the vehicle 1 further includes an actuation permission unit 36. The actuation permission unit 36 is arranged in the verification ECU 4. The actuation permission unit 36 permits starting of the engine 7 when smart authentication and biometric authentication are accomplished. The actuation permission unit 36 also permits starting of the engine 7 when smart authentication and alternative authentication are accomplished even if biometric authentication fails.

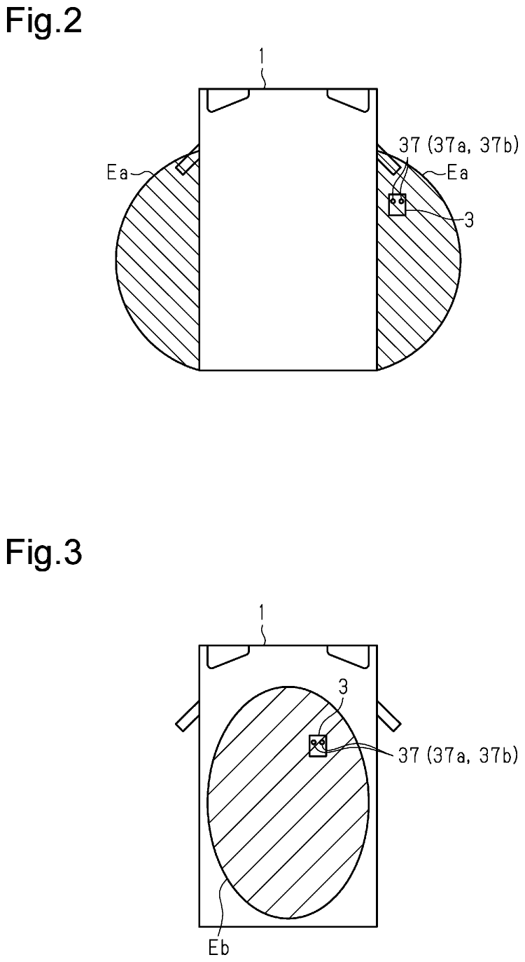

The operation of the biometric authentication electronic key system 2 will now be described with reference to FIGS. 2 to 4.

As shown in FIG. 2, the exterior transmitter 13 forms an exterior communication area Ea with LF radio waves around the vehicle 1. As one example, two exterior communication areas are illustrated, one at the driver seat side and the other at the passenger seat side. However, the number and location of the exterior communication areas may be changed in accordance with where and how many exterior transmitters 13 are arranged. The exterior transmitter 13 periodically transmits a wake signal (activation signal) to locate the electronic key 3. When receiving the periodically transmitted wake signal, the electronic key 3 returns a reply.

When the electronic key 3 enters the exterior communication area Ea, communication (exterior smart communication) is established between the vehicle 1 and the electronic key 3. This starts smart verification (exterior smart verification). Smart verification includes vehicle code verification that verifies a unique vehicle code of the vehicle 1, challenge response authentication that uses an encryption code, and electronic key ID verification that verifies the electronic key ID. The verification ECU 4 executes exterior smart verification with the electronic key 3 in the exterior communication area Ea by checking whether these verifications and authentication have all been accomplished. When determining that exterior smart verification has been accomplished, the verification ECU 4 permits or performs locking or unlocking of the door of the vehicle 1 with the body ECU 5.

The locking and unlocking of a door may be performed by, for example, a wireless key system that executes ID verification (wireless verification) when communication is established with the electronic key 3. The wireless key system is configured to switch the door between locked and unlocked states when an operation switch 37 arranged on the electronic key 3 is operated at a remote location. An unlock switch 37a, which serves as the operation switch 37 of the electronic key 3, is operated so that the electronic key 3 transmits an unlock request signal through UHF communication. When the radio wave receiver 15 receives the unlock request signal transmitted from the electronic key 3, the verification ECU 4 checks whether the electronic key ID included in the unlock request signal is valid. When ID verification is accomplished, the verification ECU 4 unlocks the door of the vehicle 1 in accordance with the unlock request signal. When a lock switch 37b of the electronic key 3 is operated, the door of the vehicle 1 is locked through communication and verification performed in the same manner as when the door of the vehicle 1 is unlocked.

Referring to FIG. 3, when the verification ECU 4 acknowledges with, for example, a door courtesy switch that the user has entered the vehicle, the verification ECU 4 transmits a wake signal from the interior transmitter 14 instead of the exterior transmitter 13. The interior transmitter 14 forms an interior communication area Eb with LF radio waves throughout the passenger compartment. When the electronic key 3 enters the interior communication area Eb, communication (interior smart communication) is established between the vehicle 1 and the electronic key 3. This starts smart verification (interior smart verification). The verification ECU 4 executes interior smart verification with the electronic key 3 in the passenger compartment to check whether vehicle code verification, challenge response authentication, and electronic key ID verification have been accomplished.

When the verification ECU 4 confirms that interior code verification, challenge response authentication, and electronic key ID verification have all been accomplished, the verification ECU 4 determines that interior smart verification has been accomplished. When the verification ECU 4 confirms that any one of interior code verification, challenge response authentication, and electronic key ID verification has failed, the verification ECU 4 determines that interior smart verification has failed. When the verification ECU 4 determines that interior smart verification has failed, the verification ECU 4 does not permit power shifting of the vehicle 1 through operation of the engine switch 18 regardless of whether biometric authentication was accomplished.

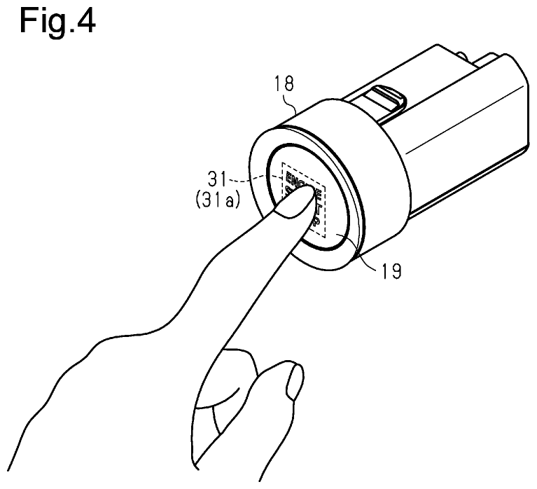

As shown in FIG. 4, when the user, who has entered the vehicle 1, starts the engine 7, the user pushes the knob 19 of the engine switch 18. When the knob 19 of the engine switch 18 is pushed, the verification ECU 4 obtains the biometric information Dbi from the sensor unit 31 (fingerprint sensor 31a), which is arranged on the knob 19 of the engine switch 18. Then, the verification ECU 4 executes biometric authentication to check whether the obtained biometric information Dbi is valid. In this case, the verification ECU 4 compares the biometric information Dbi detected by the sensor unit 31 with the biometric information Dbi stored in the memory 9 to check whether the biometric information Dbi obtained from the sensor unit 31 is valid. The verification ECU 4 determines that biometric authentication has been accomplished when the biometric information Dbi match and determines that biometric authentication has failed when the biometric information Dbi do not match.

When the verification ECU 4 determines that smart verification (interior smart verification) and biometric authentication have both been accomplished, the verification ECU 4 permits power shifting of the vehicle 1 through operation of the engine switch 18. As a result, the engine 7 can be started by operating the engine switch 18 while, for example, depressing the brake pedal.

If the verification ECU 4 determines that interior smart verification has been accomplished but biometric authentication has failed even though the biometric information Dbi was obtained from the sensor unit 31, the verification ECU 4 checks whether alternative authentication has been accomplished. Then, when the verification ECU 4 determines that smart verification and alternative authentication have both been accomplished, the verification ECU permits power shifting of the vehicle 1 through operation of the engine switch 18.

The procedure in which the verification ECU 4 permits power shifting through operation of the engine switch 18 based on whether alternative authentication is accomplished will now be described with reference to a flowchart. The procedure of interior smart verification will not be described, and the description will focus on the procedure for starting the engine 7 when the user is in the passenger compartment.

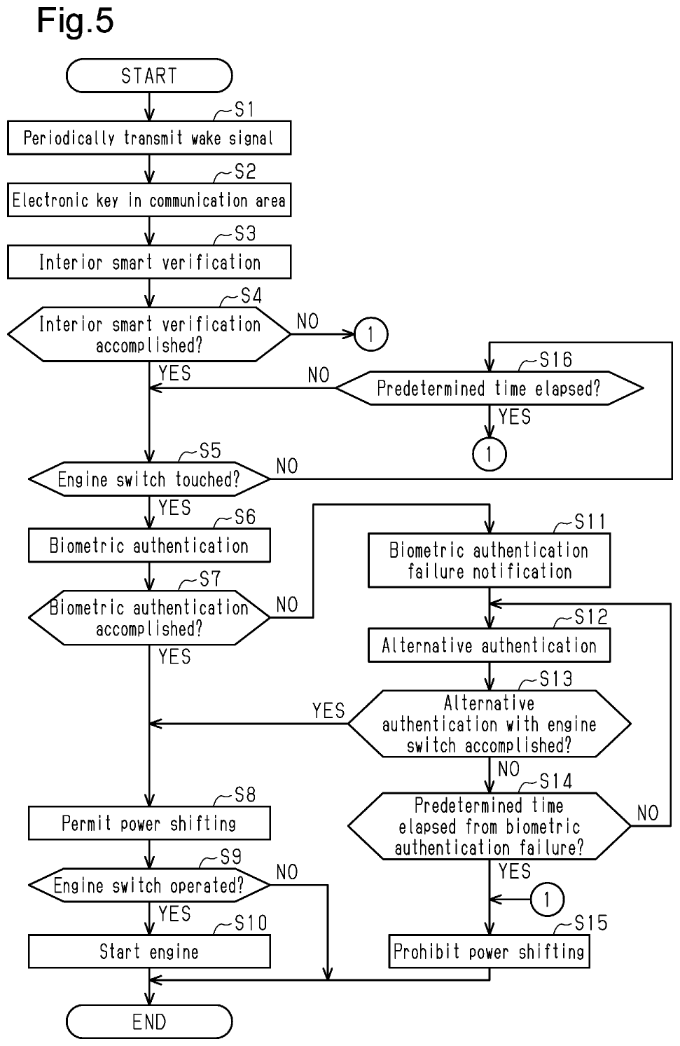

With reference to the flowchart of FIG. 5, the verification ECU 4 periodically transmits a wake signal (step S1). When the electronic key 3 is in the interior communication area Eb (step S2), the verification ECU 4 executes interior smart verification (step S3) and determines whether interior smart verification has been accomplished (step S4). It is determined that the electronic key 3 is in the interior communication area Eb when the electronic key 3 responds to the periodically transmitted wake signal. The verification ECU 4 determines whether interior smart verification has been accomplished based on whether interior code verification, challenge response authentication, and electronic key ID verification have all been accomplished.

When the verification ECU 4 determines that interior smart verification has been accomplished (YES in step S4), the verification ECU 4 determines whether the engine switch 18 has been touched (step S5).

When the verification ECU 4 determines that the engine switch 18 has been touched (YES in step S5), the verification ECU 4 executes biometric authentication (step S6) and determines whether biometric authentication has been accomplished (step S7).

When the verification ECU 4 determines that biometric authentication has been accomplished (YES in step S7), the verification ECU 4 permits power shifting (step S8) and determines whether the engine switch 18 has been operated (step S9). In this case, interior smart verification and biometric authentication have both been accomplished. Thus, the verification ECU 4 permits power shifting so as to permit starting of the engine 7. When power shifting is permitted, the user can start the engine 7 by pushing the knob 19 of the engine switch 18.

When the verification ECU 4 determines that the engine switch 18 has not been operated (NO in step S9), the verification ECU 4 ends processing.

When the verification ECU 4 determines that the engine switch 18 has not been operated (YES in step S9), the verification ECU 4 starts the engine 7 (step S10).

When the verification ECU 4 determines that biometric authentication has failed (NO in step S7), the verification ECU 4 notifies the user that biometric authentication has failed (step S11), executes alternative authentication (step S12), and determines whether alternative authentication performed with the engine switch 18 has been accomplished (step S13).

When alternative authentication performed with the engine switch 18 is accomplished (YES in step S13), the verification ECU 4 permits power shifting (step S8). In this case, although biometric authentication failed, interior smart verification and alternative authentication have both been accomplished. Thus, the verification ECU 4 permits power shifting.

If alternative authentication performed with the engine switch 18 fails (NO in step S13), the verification ECU 4 determines whether a predetermined time has elapsed from when biometric authentication failed (step S14). When determining that the predetermined time has elapsed (YES in step S14), the verification ECU 4 prohibits power shifting (step S15) and then ends processing. In this case, in addition to failure of biometric authentication, alternative authentication, which is performed as an alternative to biometric authentication, also fails. Thus, the verification ECU 4 determines not to start the engine 7. In this case, power shifting is prohibited. Alternative authentication is performed during the period from when biometric authentication fails to when the predetermined period elapses.

If the verification ECU 4 does not determine that the predetermined time has elapsed from when biometric authentication failed (NO in step S14), the verification ECU 4 executes alternative authentication again (step S12).

Further, when interior smart verification fails (NO in step S4), the verification ECU 4 prohibits power shifting (step S15) and then ends processing.

When the verification ECU 4 determines that the engine switch 18 has not been touched (NO in step S5), the verification ECU determines whether a predetermined time has elapsed (step S16). More specifically, the user can touch the engine switch 18 to perform biometric authentication until the predetermined time elapses. When the user does not touch the engine switch 18, the user has no intention to start the engine 7. Thus, subsequent determination processes are not performed. However, interior smart verification has been accomplished once. Thus, during the predetermined time (or when a predetermined condition is satisfied), there is no need to perform interior smart verification again. The determination of step S5 is repeated during the predetermined time.

When the verification ECU 4 determines that the predetermined time has not elapsed (NO in step S16), the verification ECU 4 determines again whether the engine switch 18 has been touched until the predetermined time elapses (step S5).

When the verification ECU 4 determines that the predetermined time has elapsed (YES in step S16), the verification ECU 4 prohibits power shifting (step S15) and then ends processing.

The operation and advantages of the present embodiment will now be described.

(1) The biometric authentication electronic key system 2 permits starting of the engine 7 even if biometric authentication fails as long as alternative authentication, which serves as an alternative to biometric authentication, is accomplished. More specifically, the biometric authentication electronic key system 2 permits starting of the engine 7 as long as smart verification and alternative authentication are both accomplished even if smart verification and biometric authentication are both not accomplished.

In biometric authentication such as fingerprint authentication, even if the authorized user performs biometric authentication, the user may be erroneously determined as not being the authorized user. This results in authentication failure. For example, in the case of fingerprint authentication, when the finger used for fingerprint authentication is wounded, a change will occur in the ridges and valleys (fingerprint) on the surface of the finger. This will change the fingerprint (charge) detected by the fingerprint sensor 31a. As a result, the verification ECU 4 will determine that the fingerprint of the authentic user registered to the memory 9 differs from the fingerprint detected by the fingerprint sensor 31a and that biometric authentication has failed.

In the same manner, the verification ECU 4 may determine that biometric authentication has failed when the finger used for fingerprint authentication is wet by rain or when the finger used for fingerprint authentication is dry. Charge inside the fingerprint sensor 31a has a tendency to concentrate when the finger is wet, whereas concentration of charge inside the fingerprint sensor 31a is limited when the finger is dry. In such cases, recognition of the ridges and valleys (fingerprint) in the finger will be difficult.

In this manner, even if the authentic user attempts to perform fingerprint authentication, the biometric authentication may erroneously fail. If alternative authentication is not provided, immobilizer authentication will have to be performed when biometric authentication fails. Thus, the electronic key 3 will have to be taken out. This is inconvenient.

With regard to this point, in the present embodiment, even if biometric authentication fails, starting of the engine 7 is permitted when alternative authentication, which is an alternative to biometric authentication, is accomplished. Thus, even when biometric authentication fails, there is no need to perform immobilizer authentication, and the electronic key 3 does not have to be taken out. This reduces the load on the user.

(2) Even when biometric authentication performed with the fingerprint sensor 31a of the engine switch 18 fails, the fingerprint sensor 31a of the engine switch 18 can be used to perform alternative authentication. Thus, the user need only continuously operate the engine switch 18. When shifting to authentication that uses the electronic key 3 to perform an alternative authentication, the user will suddenly have to find the electronic key 3. In contrast, in the present embodiment, alternative authentication will be accomplished when a series of operations are performed on the engine switch 18. This increases user convenience and further reduces the load on the user.

(3) In the same manner as biometric information such as the fingerprint of the user that is information unique to the user, the predetermined operation used for alternative authentication is unique information known only to the user. Thus, alternative authentication that is based on the predetermined operation that is known only to the user ensures security when starting the engine 7.

(4) Alternative authentication performed intentionally by the user is allowed for only a certain time from when determined that biometric authentication fails. Security for alternative authentication can be ensured by limiting the time for accepting alternative authentication.

The present embodiment may be modified as described below. Other embodiments, which are described below, may be combined with each other as long as there is no contradiction.

The biometric information Dbi and the alternative operation information Ds may be registered to the vehicle 1 (verification ECU 4) by, for example, operating a car navigation system in the vehicle to shift the vehicle 1 to a registration mode and touching the sensor unit 31 in this state to register the biometric information Dbi of the user. In this manner, the biometric information Dbi and the alternative operation information Ds for the vehicle 1 may be of any form.

The immobilizer antenna 27 of the electronic key 3 may be incorporated in, for example, the transmission unit 24. Further, the reception unit 23 may be configured as a transmission-reception unit and function as the immobilizer antenna 27.

A biometric authentication failure notification may be issued by the vehicle 1 (e.g., engine switch 18) or the electronic key 3. A failure notification issued by the electronic key 3 is, for example, a feedback given by noise or vibration of the electronic key 3. Feedback given by noise is implemented by, for example, a buzzer arranged on the electronic key 3. Feedback given by vibration is implemented by, for example, driving a vibration element arranged on the electronic key 3.

Key verification is not limited to smart verification and may be a different verification.

Biometric authentication may be of any type as long as the biometric information Dbi of the user is used. For example, the biometric information Dbi may be a fingerprint such as that in the present embodiment, the voice of the user, veins, iris, or the like. When using, for example, veins as the biometric information Dbi, a vein sensor is arranged in the sensor unit 31. When performing biometric authentication, the user touches the vein sensor with a finger to detect veins. Then, biometric authentication is performed based on whether the veins match the veins of the authentic user that are stored in advance.

The sensor unit 31 does not have to be arranged on the engine switch 18 and may be located at any position in the passenger compartment where the biometric information of the user can be detected when the user pushes the engine switch 18.

The smart verification system does not have to form separate areas outside and inside the passenger compartment where communication is established. For example, the smart verification system may be a system that obtains a key position by using, for example, an array antenna to measure the distance to the electronic key 3. Further, LF antennas may be arranged at the left and right sides of the vehicle body, and a response of the electronic key 3 to the radio waves of the antennas may be checked to determine whether the electronic key 3 is located outside or inside the passenger compartment.

In FIG. 5, if power shifting is permitted when biometric authentication is accomplished (step S7 and S8), it is determined whether the engine switch has been operated. However, step S9 can be omitted. More specifically, the verification ECU 4 can start the engine 7 when biometric authentication is accomplished (YES in step S7) regardless of whether the engine switch 18 is operated.

In the above embodiment, the verification ECU 4 (key verification unit 32, biometric authentication determination unit 33, failure notification unit 34b, the alternative authentication unit 35, and actuation permission unit 36) may be configured by one or more dedicated circuits or one or more processors. For example, the verification ECU 4 may include one or more processors and a memory (computer readable non-transitory storage medium) storing one or more programs including a group of commands executable by the processor. When the group of commands is executed, the processor performs the actions of the biometric authentication electronic key system 2 in accordance with the present disclosure. For example, the program includes the group of commands for having the processor execute processes corresponding to the verification ECU 4 in the sequences of S1 to S15 illustrated in FIG. 5. Accordingly, a computer-readable non-transitory medium storing such a program can be prepared based on the present disclosure.

1. An engine switch device that permits starting of an engine with an engine switch if biometric authentication executed based on biometric information detected by a biometric authentication sensor is accomplished, the engine switch device comprising:
a biometric authentication determination unit configured to determine that the biometric authentication has been accomplished if biometric information that is stored in advance matches the biometric information detected by the biometric authentication sensor;
an alternative authentication unit configured to execute alternative authentication based on a predetermined operation performed on the engine switch by a user if the biometric authentication fails; and
an actuation permission unit configured to permit or perform starting of the engine if the biometric authentication is accomplished and further configured to permit or perform starting of the engine if the biometric authentication fails but the alternative authentication performed by the alternative authentication unit is accomplished.

2. The engine switch device according to claim 1, comprising
a key verification unit configured to execute key verification based on whether an electronic key ID that is transmitted through wireless communication from an electronic key held by the user matches a registration ID that is stored in advance, wherein
the actuation permission unit is configured to permit or perform starting of the engine if the biometric authentication and the key verification are both accomplished, and
the actuation permission unit is further configured to permit or perform starting of the engine if the biometric authentication fails but the alternative authentication and the key verification are both accomplished.

3. The engine switch device according to claim 1, further comprising a failure notification unit configured to notify the user of failure of the biometric authentication using the engine switch or an electronic key held by the user if the biometric authentication fails.

4. The engine switch device according to claim 1, wherein the alternative authentication is performed only during a predetermined time from when failure of the biometric authentication is determined.

5. The engine switch device according to claim 1, further comprising:
the engine switch that includes an operation surface; and
the biometric authentication sensor including a fingerprint sensor arranged on the operation surface of the engine switch,
wherein the fingerprint sensor is configured to detect a fingerprint serving as the biometric information.

6. The engine switch device according to claim 5, wherein
the fingerprint sensor detects the predetermined operation performed on the engine switch by the user during the alternative authentication, and
the alternative authentication unit is further configured to determine that the alternative authentication has been accomplished if a touching action performed by the user on the operation surface of the engine switch matches an action that is stored in advance.

7. The engine switch device according to claim 5, wherein the predetermined operation includes touching the operation surface of the engine switch for a number of times that is registered in advance.

8. The engine switch device according to claim 5, wherein the predetermined operation includes operating and touching the operation surface of the engine switch along a route that is registered in advance.

9. A system that starts an engine of a vehicle, the system comprising:
one or more processors; and
a memory connected to the one or more processors to store commands executable by the one or more processors and biometric information of a user of the vehicle,
wherein the one or more processors executes the commands to
determine that biometric authentication has been accomplished if the biometric information stored in the memory matches biometric information detected by a biometric authentication sensor,
execute alternative authentication based on a predetermined operation performed on an engine switch by a user if determined that the biometric authentication has failed,
permit or perform starting of the engine if determined that the biometric authentication has been accomplished, and
permit or perform starting of the engine if the alternative authentication is accomplished when determined that the biometric authentication has failed.
